(19) United States
(12) Patent Application Publication
(10) Pub. No.: US 2013/0166114 A1
(43) Pub. Date: Jun. 27, 2013

(54) Worker Protection Method

(71) Applicants: Stephen Baines, Brisbane (AU); David McMah, Brisbane (AU)

(72) Inventors: Stephen Baines, Brisbane (AU); David McMah, Brisbane (AU)

(73) Assignee: AURIZON OPERATIONS LIMITED, Brisbane Queensland (AU)

(21) Appl. No.: 13/820,787

(22) PCT Filed: Sep. 6, 2011
(86) PCT No.: PCT/AU11/01149

§ 371 Date: Mar. 5, 2013

(30) Foreign Application Priority Data
Sep. 6, 2010 (AU) 2010903992
Sep. 6, 2010 (AU) 2010903993
Oct. 12, 2010 (AU) 2010904562
Jan. 4, 2011 (AU) 2011900013

(51) Int. Cl. B61L 23/06; G08B 21/02

(52) U.S. Cl. CPC B61L 23/06; G08B 21/02
USPC 701/20; 340/539.13

(57) ABSTRACT

The present invention relates to a portable computational device for protecting at least one worker. The device is configured to send a protection request for allocation of a protection zone for at least one worker. The device is also configured to receive confirmation that the protection zone has been allocated. In one embodiment, the device is configured to both monitor the location of the worker relative to the protection zone and determine whether a hazard is co-incident with the protection zone.

### TECHNICAL FIELD

The present invention generally relates to a worker protection method. The present invention has particular, although not exclusive application to protecting railroad workers.

### BACKGROUND

The reference to any prior art in this specification is not, and should not be taken as an acknowledgement or any form of suggestion that the prior art forms part of the common general knowledge.

Teams of railroad workers invariably repair and maintain railroad tracks. Each team generally includes a team coordinator who coordinates the activities of the team members.

In practice, the team is often required to work proximal to a railroad track during times when trains are running. The team leader in radio communication with a command centre can verbally request that the command centre divert trains to other tracks to ensure team safety. However, the applicant is aware of instances where the command centre did not correctly act upon such a request, and a train has still been diverted along a track upon which the team is working which is extremely dangerous.

The Applicant perceives a need for an improved protection method for protecting the team.

### SUMMARY OF THE INVENTION

According to one aspect of the present invention, there is provided a worker protection method for protecting at least one worker using a portable computational device, the method including the steps of:
sending a protection request for avocation of a protection zone for at least one worker; and
receiving confirmation that the protection zone has been allocated.

The protection zone may be circular. The protection zone may be static or dynamic. The received confirmation may include verbal confirmation via voice communication.

The method may further include the step of monitoring the location of the worker relative to the protection zone. The step of monitoring may involve continually receiving the location of the worker. The method may further involve the step of sending a warning alarm to each worker or a command centre based upon the location of the worker relative to the protection zone. The warning alarm may have a severity indicator.

The method may further include the step of determining that a hazard is co-incident or intersecting with the protection zone. The method may further include the step of sending a warning notification to the worker regarding the hazard, The hazard may be related to a vehicle or plant. The hazard may be a train or protection zone of the train, and the method may further include the step of sending a warning notification to the train. The method may further include the step of automatically reducing the speed of the train upon receipt of the warning notification.

The method may further involve the step of sending a relinquishment request for relinquishing (or handing back) the protection zone upon completion of work by the worker.

The method may further include the step of receiving health information relating to the worker.

According to another aspect of the present invention, there is provided a portable computational device for protecting at least one worker, the device configured to:
send a protection request for allocation of a protection zone for at least one worker; and
receive confirmation that the protection zone has been allocated.

The device may include a global positioning system unit. The device may include a transceiver for communicating with handheld devices borne by the workers, a command centre and a vehicle or plant. The portable device may be configured to periodically verify that it is in communication with each handheld device. The device may include a biometric sensor arrangement for authorizing operation of the device. Alternatively, the device may include an identification reader (e.g. RFT) or barcode reader) for identifying an identifier borne by an operator prior to authorizing operation of the device. The device may have a touch screen display user interface. The touch screen display may be configured to display a map showing the protection zone and the location of the workers relative to the protection zone. The map may further show the location of a train relative to the protection zone.

According to another aspect of the present invention, there is provided a worker protection method for protecting at least one worker using a computer system, the method including the steps of:
receiving a protection request for allocation of a protection zone for at least one worker;
allocating said protection zone; and
sending confirmation that the protection zone has been allocated.

The method may further include the step of relinquishing the protection zone.

According to another aspect of the present invention, there is provided a computer system for protecting at least one worker, the computer system being configured to:
receive a protection request for allocation of a protection zone for said at least one worker;
allocate said protection zone; and
send confirmation that the protection zone has been allocated.

### BRIEF DESCRIPTION OF THE DRAWINGS

Preferred features, embodiments and variations of the invention may be discerned from the following Detailed Description which provides sufficient information for those skilled in the art to perform the invention, The Detailed Description is not to be regarded as limiting the scope of the preceding Summary of the invention in any way. The Detailed Description will make reference to a number of drawings as follows:

FIG. 1 is a schematic view of a railroad worker protection system in accordance with an embodiment of the present invention;

FIG. 2 is a block diagram of a portable computational device of the worker protection system of FIG. 1:

FIG. 3 is a flowchart of a railway worker protection method in accordance with an embodiment of the present invention, the method performed using the protection system of FIG. 1.

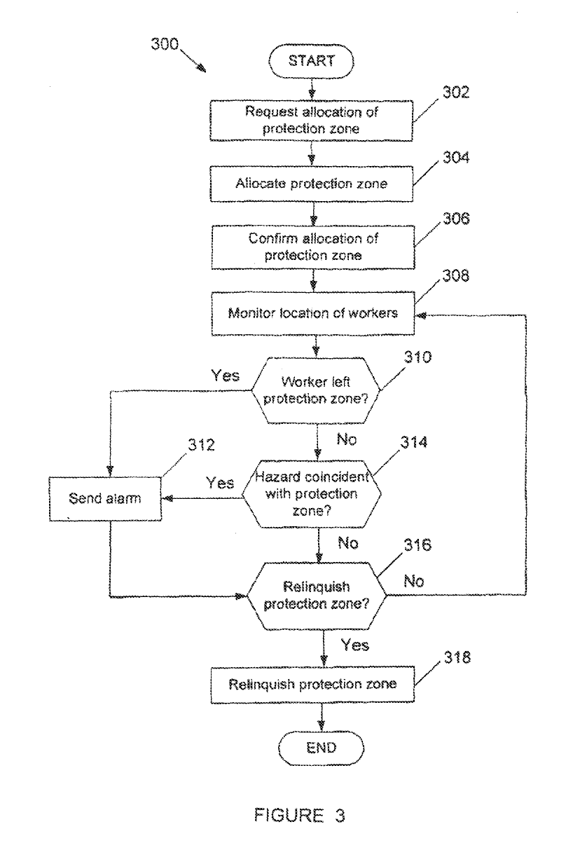

### DETAILED DESCRIPTION OF PREFERRED EMBODIMENTS

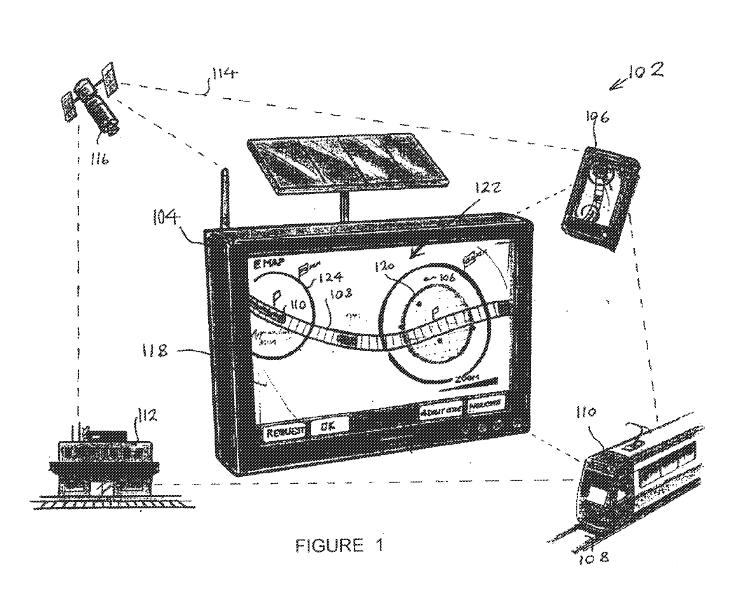

In accordance with an embodiment of the present invention, there is provided a railroad worker protection system 102 as shown in FIG. 1. The system 102 can be used to protect a team of railway workers using a portable computational device 104 carried by a leader of the team. The system 102 further includes handheld devices 6 carried by respective other workers of the team, The team works proximal to a railway track 108 along which a train 110 can pass.

Each of the portable computational device 104, handheld devices 106 and train 110 are in two-way communication with a computer system of a command centre 112 via a communications network 114 (generally designated by dashed lines). Furthermore, each of these system entities can communicate with each other via the network 114. The network 114 can include communication via satellite 116, dedicated radio and mobile phone infrastructure.

The portable device 104 can monitor the real-time location of the handheld devices 106 carried by the team. The portable device 104 has a touch screen display user interface 118. The portable device 104 is configured to send, to the command centre 112, a protection request for allocation of a circular protection zone 120 for the team, The team can safely work within this protection zone 120. The portable device 104 is further configured to receive confirmation from the command centre 112 that the protection zone 120 has been allocated. Subsequent to allocation, the touch screen display 118 is configured to display a map 122 showing the protection zone 120 and the location of the handheld devices 106 carried by the workers relative to the protection zone 120.

The map 122 further shows the location of the tracks 108, train 110 and a train protection zone 124 relative to the team protection zone 120. In the real-time event of the train protection zone 124 and the team protection zone 120 coinciding (or intersecting), the portable device 104 sends an alarm to each handheld device 106, the command centre 112 and the train 110. If handheld devices 106 carried by the workers leave the protection zone 120, the portable device 104 sends a warning alarm to each handheld device 106 and the computer system of the command centre 112.

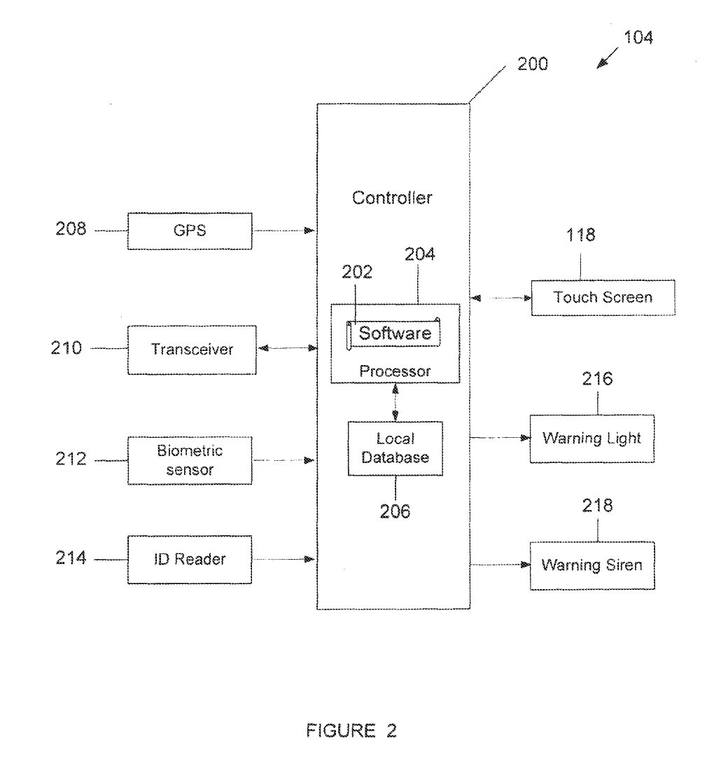

Turning to FIG. 2, the portable device 104 includes a controller 200 for controlling the operation of the device 104. The controller 200 contains a software product 202 in resident memory. In turn, the software product 202 contains computer readable instructions for execution by a processor 204 of the controller 200 to perform the railway worker protection method outlined below. The processor 204 is interfaced to a storage device (e.g. hard disc) containing a map feature database 206.

The portable device 104 further includes a Global Positioning System (GPS) 208 for determining the location of the portable device 104. The portable device may also receive asset information for determining the location of the portable device 104 and team leader. This asset information may relate to asset numbers, monument numbers or identification numbers and tags that are present on infrastructure assets around a track worksite.

The portable device 104 further includes a transceiver 210 for enabling communication with the other system entities via the network 114. The portable device 104 also includes a biometric sensor arrangement 212 for authorizing operation of the device 104 by the team leader. Alternatively, the device 104 includes an identification reader 214 (e.g. RFID or barcode reader) for identifying an identifier (e.g. RFID tag or barcode) borne by the team leader prior to authorizing operation of the device 104 by the team leader.

The portable device 104 also includes a warning light 216 and warning siren 218 for providing visual and audible warnings to the team leader.

Each handheld device 106 and the computer system of the command centre 112 is of like construction to the portable device 104 of FIG. 2.

A railroad worker protection method 300 performed using the protection system 102 is now described.

Initially, the team of railway workers make their way to a worksite adjacent the railway track 108. The team leader carries the portable device 104 and the other workers carry the handheld device 106.

At step 302, the portable device 104 sends a protection request message for allocation of the protection zone 120 for the team. In turn, the computer system of the command centre 112 receives the protection request message.

At step 304, the computer system of the command centre 112 allocates the protection zone 120, The protection zone 120 is typically static and circular with the instantaneous location of the portable device 104 at its centre. Accordingly, the protection zone 120 is located proximal the railroad track 108 or can be located near some other known static object (e.g level crossing, location marker, signal lights, access gate, etc.).

At step 306, the computer system of the command centre 112 sends confirmation as an electronic message that the protection zone 120 has been allocated. In turn, the portable device 104 receives the confirmation. The received confirmation may also include a verbal confirmation via voice communication.

At step 308, the portable device 104 monitors the location of the handheld devices 106 carried by the workers relative to the protection zone 102. In this manner, the portable device 104 periodically receives the GPS location of each handheld device 106.

At query step 310, the portable device 104 queries whether any of handheld devices 106 carried by the workers have left the protection zone 120. If so, at step 312 the portable device 104 sends an appropriate warning alarm to each handheld device 106 and the computer system of the command centre 112, as well as activates the warning light 216 and warning siren 218. If not, the method 300 proceeds to step 314.

At query step 314, the portable device 104 queries whether a hazard is co-incident (or intersects) with the protection zone 120. The hazard is the train 110 or the train protection zone 124 of the train 110. If a hazard is co-incident with the protection zone 120, the method 300 proceeds to step 312 where the portable device 104 sends an appropriate warning alarm to each handheld device 106, the computer system of the command centre 112 and the train 110. The portable device 104 also activates the warning light 216 and warning siren 218. The speed of the approaching train 110 can be automatically reduced (to zero) upon receipt of the warning alarm.

If a hazard is not co-incident with the protection zone 120, the method 300 proceeds to step 316.

At step 316, the portable device 104 queries whether input is received from the team leader indicating that the protection zone can be relinquished upon completion of work by the team. If so, the portable device 104 sends a relinquishment request to the computer system of the command centre 112. in turn at step 318, the command centre computer system receives the relinquishment request and relinquishes the protection zone 120.

If at step 316, no input is received from the team leader indicating that the protection zone can be relinquished, the method 300 returns to step 308.

The portable device 104 is configured to periodically verify with a heartbeat signal that it is in communication with each handheld device 106 when the protection zone 120 is allocated. In the event that the portable device 104 loses communication with one of the handheld devices 106, the portable device 104 generates an audible and visual alarm with the warning siren 218 and the warning light 216.

Each handheld device 106 is configured to monitor health information (e.g. heartbeat) of its associated worker and to send the health information to the portable device 104. The portable device 104 is configured to receivie the health information and can generate a health alarm responsive to determining that the health information is indicative of unacceptable health. The portable device 104 is configured to send the health alarm to each handheld device 106 and the command centre computer system.

A person skilled in the art will appreciate that many embodiments and variations can be made without departing from the ambit of the present invention.

The portable device 104 of the preferred embodiment was configured to send a warning alarm of high severity to each worker's handheld device or the command centre 112 upon detecting that one of the workers has left the protection zone 120. In another embodiment, the portable device 104 is configured send a warning alarm of lesser severity upon detecting that one of the workers is about to leave (or is in close proximity to the edge of) the protection zone 120 and is in a cautionary severity area.

At step 314 above, the portable device 104 queries whether a hazard in the form of a train 110 or train protection zone 124 is co-incident (or intersects) with the worker protection zone 120. In another embodiment, the hazard may instead include a railroad maintenance truck or associated truck protection zone.

In the preferred embodiment, the worker protection zone 120 was static around the work site, In an alternative embodiment, the worker protection zone 120 may be dynamic (i.e. able to vary in location) and have the portable device 104 at its centre.

In one embodiment, the protection system 102 may include a automatic track warning system (ATWS) which detects the real-time location of the train 110. The ATWS can include RF, RADAR, and/or switch activation detectors.

In compliance with the statute, the invention has been described in language more or less specific to structural or methodical features, It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

The claims defining the invention are as follows:

1. A worker protection method for protecting at least one worker using a portable computational device, the method including the steps of:
sending a protection request for allocation of a protection zone for at least one worker; and
receiving confirmation that the protection zone has been allocated,

2. A worker protection method as claimed in claim 1, wherein the protection zone is either static or dynamic.

3. A worker protection method as claimed in claim 1, further including the step of monitoring the location of the worker relative to the protection zone.

4. A worker protection method as claimed in claim 3, wherein the step of monitoring involves continually receiving the location of the worker.

5. A worker protection method as claimed in claim 3, further including the step of sending a warning alarm to each worker or a command centre based upon the location of the worker relative to the protection zone.

6. A worker protection method as claimed in claim 5, wherein the warning alarm has a severity indicator.

7. A worker protection method as claimed in claim 1, further including the step of determining that a hazard is co-incident or intersecting with the protection zone.

8. A worker protection method as claimed in claim 7, further including the step of sending a warning notification to the worker regarding the hazard.

9. A worker protection method as claimed in claim 8, wherein the hazard is related to a vehicle or plant.

10. A worker protection method as claimed in claim 8, wherein the hazard is a train or protection zone of the train, and the method further includes the step of sending a warning notification to the train.

11. A worker protection method as claimed in claim 10, wherein the method further includes the step of automatically reducing the speed of the train upon receipt of the warning notification.

12. A worker protection method as claimed in claim 1, wherein the method further involves the step of sending a relinquishment request for relinquishing the protection zone upon completion of work by the worker

13. A worker protection method as claimed in claim 1, further including the step of receiving health information relating to the worker.

14. A worker protection method as claimed in claim 1, wherein the received confirmation includes verbal confirmation via voice communication.

15. A worker protection method as claimed in claim 1, further including the step of allocating said protection zone.

16. A portable computational device for protecting at east one worker, the device configured to:
send a protection request for allocation of a protection zone for at least one worker; and
receive confirmation that the protection zone has been allocated.

17. A portable computational device as claimed in claim 16, configured to monitor the location of the worker relative to the protection zone.

18. A portable computational device as claimed in claim 16, configured to determine whether or not a hazard is co-incident or intersecting with the protection zone.

19. A portable computational device as claimed in claim 16, configured to send a relinquishment request for relinquishing the protection zone upon completion of work by the worker.

20. A worker protection method as claimed in claim 1, configured to receiving health information relating to the worker.
